(19) United States
(12) Patent Application Publication
(10) Pub. No.: US 2010/0039074 A1
(43) Pub. Date: Feb. 18, 2010

(54) SMART ALTERNATOR

(75) Inventors: Helge Brand, Isernhagen (DE); Eckard Scholz, Eldingen (DE)

Correspondence Address: CANTOR COLBURN, LLP, 20 Church Street, 22nd Floor, Hartford, CT, 06103, US

(73) Assignee: Baker Hughes Incorporated, Houston, TX (US)

(21) Appl. No.: 12/192,500

(22) Filed: Aug. 15, 2008

(51) Int. Cl. H02P 9/48

(52) U.S. Cl. 322/28; 175/104

(57) ABSTRACT

An alternator an electronic voltage pre-regulation circuit adapted for incorporation into a drill string is provided and includes: a plurality of n-phase generators for providing alternating current (AC), wherein the AC of each generator is rectified to a direct current (DC) voltage using a respective rectifier to provide a DC power supply, and each DC power supply is arranged in series for being one of connected and disconnected from an output of the alternator. A method and a drill string are provided.

### BACKGROUND OF THE INVENTION

1. Field of the Invention

The invention disclosed herein relates to power supplies for downhole tooling and, in particular, to an alternator having electronic voltage pre-regulation and adapted for use with any subsequent switch mode power supply or linearly regulated voltage control.

2. Description of the Related Art

Present day drilling rigs used for gas and oil exploration involve sophisticated technologies. Such technologies include various measurement apparatus. The measurement apparatus and other such devices necessarily consume power for performing assigned tasks. Thus, drill strings often include some form of power supply, such as an alternator, to provide power to instrumentation that is on board.

Alternators within a drill string often take advantage of rotational energy, flow of drilling mud and other forms of energy to generate electrical energy for power consuming downhole tools. Variability in drilling operational factors lead to variable voltage output. For example variations in flow rates of drilling mud will cause fluctuations in voltage output. Downhole tools generally require or benefit from stable supply voltage.

In conventional downhole applications electronics, such as switched power supplies are running directly behind a rectifier that is fed by an alternator. The output voltage of the rectifier changes in a wide range, because the alternator output voltage increases linearly to an increasing speed of its rotor. Ultimately subsequent electronics have to work in a wide voltage range even at high voltages. High voltages in an electronic system lead to high switching losses, heatup, component stress, reduced reliabilty, reduced possibility for component choice. Further low voltages could lead to high currents and high conductive losses.

Thus, what is needed is a power supply for use in downhole tooling and that provides an output voltage that can be held in a narrow range. The voltage level should be provided reliably within a narrow range so that various problems, such as those mentioned above, are addressed or eliminated.

### BRIEF SUMMARY OF THE INVENTION

In one embodiment, the invention includes an alternator an electronic voltage pre-regulation circuit adapted for incorporation into a drill string, the alternator including: a plurality of n-phase generators for providing alternating current (AC), wherein the AC of each generator is rectified to a direct current (DC) voltage using a respective rectifier to provide a DC power supply, and each DC power supply is arranged in series for being one of connected and disconnected from an output of the alternator.

In another embodiment, the invention includes a method for providing output voltage to electronics comprised within a drill string downhole, the method including: producing alternating current (AC) using at least one n-phase generator from a plurality of n-phase generators; rectifying the alternating current from each n-phase generator to provide a direct current (DC) as the output voltage; monitoring the output voltage; and if the output voltage is below a desired level, connecting another n-phase generator in series with the at least one n-phase generator to increase the output voltage; and if the output voltage is above a desired level, disconnecting one of the plurality of n-phase generators from the at least one n-phase generator for decreasing the output voltage.

In a further embodiment, the invention includes a drill string for drilling into an earth formation, the drill string including: a source of mechanical energy for turning an alternator, the alternator including a plurality of n-phase generators for providing alternating current (AC), wherein the AC of each generator is rectified to a direct current (DC) voltage using a respective rectifier to provide a DC power supply, and each DC power supply is arranged in series for being one of connected and disconnected from an output of the alternator.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts aspects of a drill string including a smart alternator as a power supply;

FIG. 2 is a schematic diagram depicting an embodiment of the smart alternator;

FIG. 3 depicts performance of the smart alternator for an embodiment of a three phase system; and

FIG. 4 depicts aspects of a circuit diagram for the smart alternator.

### DETAILED DESCRIPTION OF THE INVENTION

Disclosed is a smart alternator for providing power to power consuming components downhole. Generally, the smart alternator has a narrow output voltage range in comparison to conventional alternators where the spread of the input voltage range correlates to a spread in flowrate of drilling mud. The smart alternator overcomes inadequacies of prior art designs that are associated with or a result of high flowrate spread that leads to very high voltages in electronic systems connected to the alternators

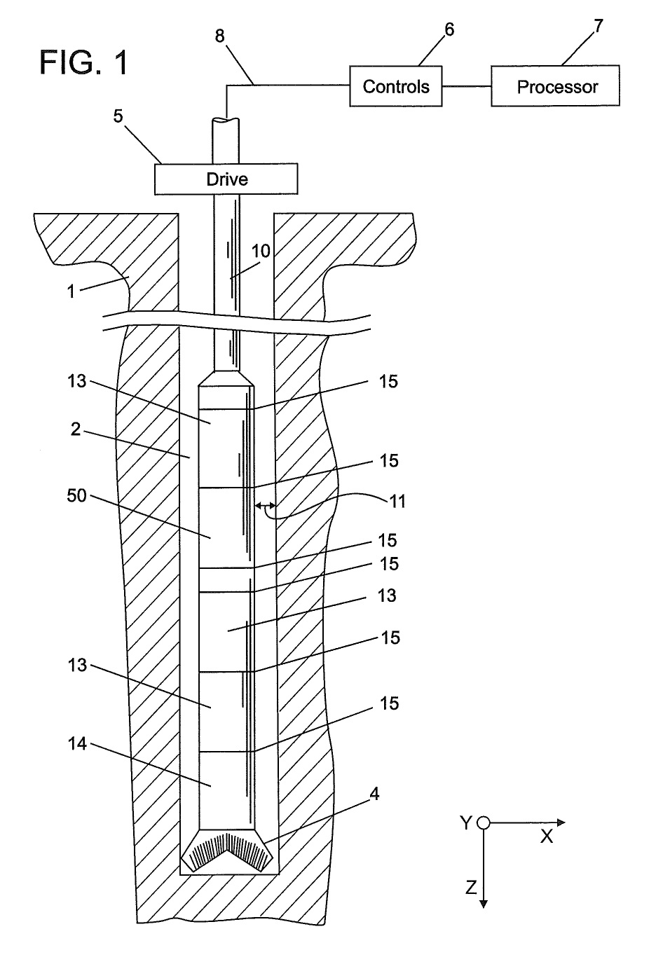

Referring now to FIG. 1, there are shown aspects of an exemplary embodiment of a smart alternator 50 for powering components of a drill string 10. The smart alternator 50 is included within the drill string 10 that includes a drill bit 4. The drill string 10 provides for drilling of a borehole 2 into earth formations 1. The drill bit 4 is attached to a drill collar 14. The drill string 10 may include a plurality of couplings 15 for coupling various power consuming components 13 into the drill string 10. In general, the power consuming components 13 are powered by the smart alternator 50.

Generally, the borehole 2 is filled with drilling mud. Drilling mud may be introduced for a variety of reasons, including provision of a pressure barrier or driving a mud turbine that is coupled to an alternator. Generally, the smart alternator 50 may be used with any type of drilling mud to provide input mechanical energy.

In some embodiments, a drive 5 is included and provides for rotating the drill string 10 and may include apparatus for providing depth control. Control of the drive 5 and the smart alternator 50 is achieved by operation of controls 6 and a processor 7 coupled to the drill string 10. The controls 6 and the processor 7 may provide for further capabilities. For example, the controls 6 may be used to indirectly control and operate the smart alternator 50, while the processor 7 receives and at least one of packages, transmits and analyzes data provided by the drill string 10 and/or components 13 therein. In various embodiments of instruments for logging while drilling (LWD), the smart alternator 50 provides power for collecting data downhole.

Smart alternator 50 rotating speed may be controlled by surface control 6 and processor 7.

In general, and as discussed herein, the smart alternator 50 receives mechanical energy from a flow of drilling mud. Conversion of mechanical energy into an electrical signal using an alternator downhole generally includes apparatus (such as a turbine) as known in the art. Accordingly, techniques for receiving and converting mechanical energy are not discussed with any particularity further herein.

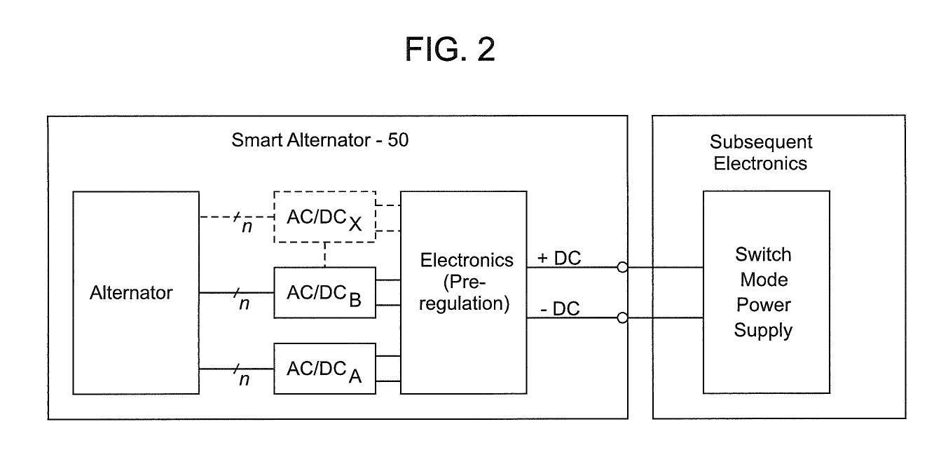

The smart alternator 50 includes a generator of any number (denoted as “X”) of n-phase (often being three-phase) alternating current (AC) systems at the output. This is illustrated in FIG. 2.

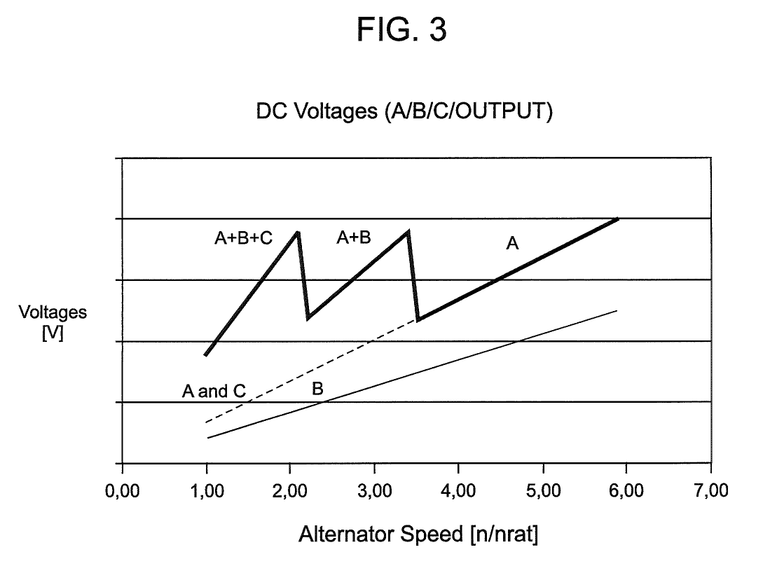

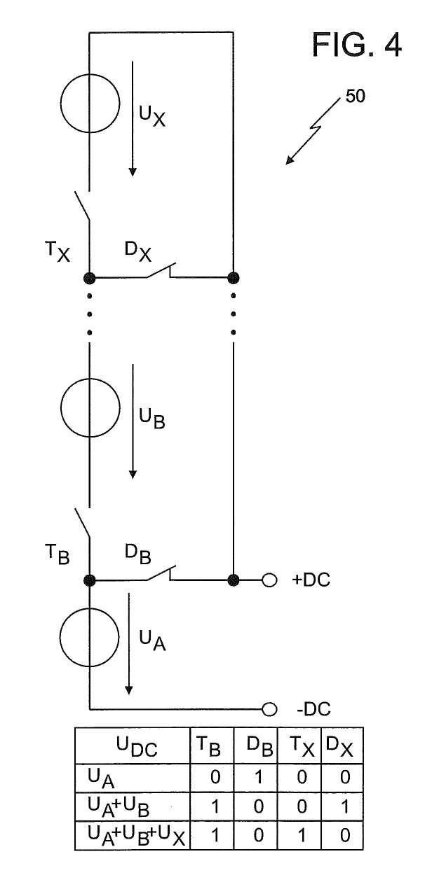

With reference to FIG. 2, the n-phase AC voltage is rectified to a direct current (DC) voltage using rectifiers. The DC voltages are stacked with a suitable electronics, such as those that would operate according to the principles shown in FIG. 4. By connecting or disconnecting each DC voltage in series, output voltage from the smart alternator 50 may be increased or decreased as desired. FIG. 3 provides an exemplary output characteristic for the output voltage of a three-stage configuration of the smart alternator 50. The individual voltages A, B and C increase linearly with increased speed of the generator, as in a conventional alternator. The sum of voltages that become the output voltage from the smart alternator 50 is realized by stacking the individual voltages. In short, a zig-zag voltage curve results.

Now with reference to FIGS. 2 and 4 in more detail, the smart alternator 50 includes more than one conventional three phase winding system. However, power density is generally equivalent to other prior art alternators. In some embodiments, the smart alternator 50 includes two or three independent three phase systems and power electronics. Each of the three-phase outputs are rectified. For example, the outputs may be rectified using a B6 rectifier that has at its output a control electronic and a power switch. With a power switch (e.g. a MOSFET) the rectified voltages can be switched in series (at a low voltage output) or disconnected from the system. By way of example, disconnection may occur if the sum of the in series connected voltages increases to or above predetermined level. As an example, in one embodiment, the smart alternator 50 having 3×3 phases and an upper voltage level will switch back two times from an upper level to a lower level over the whole flow range.

In support of the teachings herein, various analysis components may be used, including digital and/or an analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), a vacuum supply, pressure supply, a motive force (such as a translational force, propulsional force or a rotational force), a magnet, electromagnet, sensor, controller, electrical unit or electromechanical unit may be included in support of the various aspects discussed herein or in support of other functions beyond this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. An alternator comprising an electronic voltage pre-regulation circuit adapted for incorporation into a drill string, the alternator comprising:
a plurality of n-phase generators for providing alternating current (AC), wherein the AC of each generator is rectified to a direct current (DC) voltage using a respective rectifier to provide a DC power supply, and each DC power supply is arranged in series for being one of connected and disconnected from an output of the alternator.

2. The alternator as in claim 1, further comprising control circuitry for controlling the connection and the disconnection of each DC power supply.

3. The alternator as in claim 2, further comprising switches for the connection and disconnection.

4. The alternator as in claim 3, wherein the switches comprise at least one of MOSFET switches and power diodes.

5. The alternator as in claim 1, wherein each of the n-phase generators comprise a three-phase generator.

6. The alternator as in claim 1, wherein each of the n-phase generators produces an output of about 200 volts.

7. The alternator as in claim 1, further comprising an electronic circuit that regulates output voltage to a substantially constant voltage.

8. A method for providing output voltage to electronics comprised within a drill string downhole, the method comprising:
producing alternating current (AC) using at least one n-phase generator from a plurality of n-phase generators;
rectifying the alternating current from each n-phase generator to provide a direct current (DC) as the output voltage;
monitoring the output voltage; and
if the output voltage is below a desired level, connecting another n-phase generator in series with the at least one n-phase generator to increase the output voltage; and
if the output voltage is above a desired level, disconnecting one of the plurality of n-phase generators from the at least one n-phase generator for decreasing the output voltage.

9. The method as in claim 8, wherein the monitoring is performed on one of a periodic basis and a continuous basis.

10. A drill string for drilling into an earth formation, the drill string comprising:
a source of mechanical energy for turning an alternator, the alternator comprising a plurality of n-phase generators for providing alternating current (AC), wherein the AC of each generator is rectified to a direct current (DC) voltage using a respective rectifier to provide a DC power supply, and each DC power supply is arranged in series for being one of connected and disconnected from an output of the alternator.

11. The drill string as in claim 10, wherein the output from the alternator is adapted for providing power to power consuming components within the drill string.
